(19) United States
(12) Patent Application Publication
(10) Pub. No.: US 2017/0143035 A1
(43) Pub. Date: May 25, 2017

(54) Smoking Apparatus with Wireless Communication Capability

(71) Applicant: Zachary A. Pucci, Keansburg, NJ (US)

(72) Inventor: Zachary A. Pucci, Keansburg, NJ (US)

(21) Appl. No.: 15/286,350

(22) Filed: Oct. 5, 2016

Related U.S. Application Data
(60) Provisional application No. 62/258,624, filed on Nov. 23, 2015.

(51) Int. Cl. A24F 1/30; H02J 7/02; H04R 1/02; H04W 4/00

(52) U.S. Cl. CPC A24F 1/30; H04W 4/008; H02J 7/025; H04R 1/028; H04R 2420/07

(57) ABSTRACT

A smoking apparatus with wireless communication capability is a device that is used to combust an herbal substance for smoking. The device includes a smoking device and an electronic base that may be tethered to a user's electronic device via a wireless communication module. The smoking device is separable from the electronic base for convenient cleaning. At least one audio-output device allows the device to output audio such as music. An audio-capture device is able to capture incoming audio, allowing telephone calls to be made through the device once the device is tethered to the user's electronic device. At least one user-input device is present on the device to enable the user to input commands. Electrical power to the device's electronic components are provided by a power supply.

The current application claims a priority to the U.S. Provisional Patent application Ser. No. 62/258,624 filed on Nov. 23, 2015.

### FIELD OF THE INVENTION

The present invention relates generally to a smoking and communication device. More specifically, the present invention is a smoking apparatus with wireless communication capability that may be wirelessly connected to a user's electronic device.

### BACKGROUND OF THE INVENTION

Smoking apparatuses are utilized for a wide variety of medicinal and social purposes. Smoking apparatuses are available in many forms including common devices such as bongs, hookahs, and vaporizers. The increasing popularity of these smoking apparatuses has led to numerous innovations in the form of increased features and functionality of the smoking apparatuses. For example, smoking apparatuses that are utilized with combustible substances such as tobacco and herbs often include intricate internal chambers for manipulating the smoke that is produced by combusting the substances. Personal vaporizers now often include integrated sensors that are able to monitor variables such as electrical information, vapor temperature, and battery life. These devices often also include internal control units that may be utilized to adjust the performance of the devices as well as user preferences. The increased popularity of various types of smoking apparatuses opens the possibility of even further innovations for the apparatuses.

The present invention is a smoking apparatus with wireless communication capability that may be wirelessly connected to a user's electronic device. The present invention may be utilized as a conventional smoking apparatus for smoking combustible substances such as tobacco and herbs. In addition, the present invention may be wirelessly connected to a user electronic device such as, but not limited to, a smartphone. The present invention may be utilized to perform various functions of the user electronic device. These functions include, but are not limited to, placing and receiving voice calls and playing audio media.

### BRIEF DESCRIPTION OF THE DRAWINGS

FIG. 1 is a front perspective view of the present invention.

FIG. 2 is a rear perspective view of the present invention.

FIG. 3 is a front view of the present invention.

FIG. 4 is a rear view of the present invention.

FIG. 5 is a cross-sectional view of the present invention taken along line A-A of FIG. 4.

FIG. 6 is an exploded front perspective view of the present invention.

FIG. 7 is a diagram depicting electronic connections of the present invention.

FIG. 8 is a diagram depicting electrical connections of the present invention.

### DETAIL DESCRIPTIONS OF THE INVENTION

All illustrations of the drawings are for the purpose of describing selected versions of the present invention and are not intended to limit the scope of the present invention.

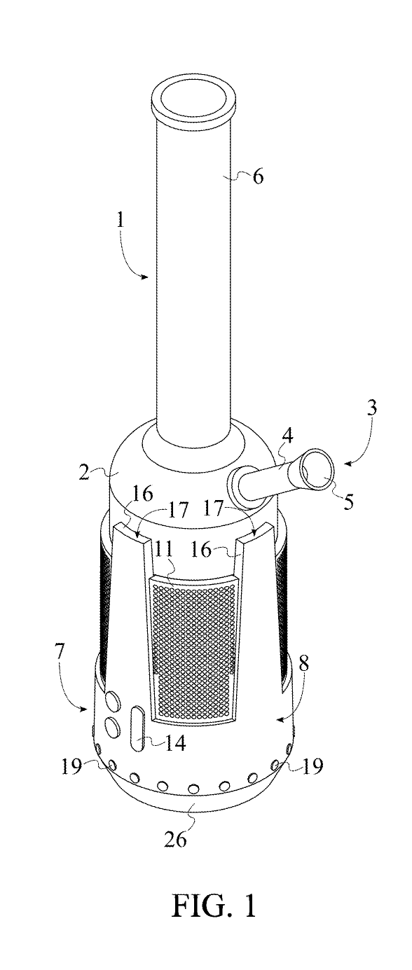

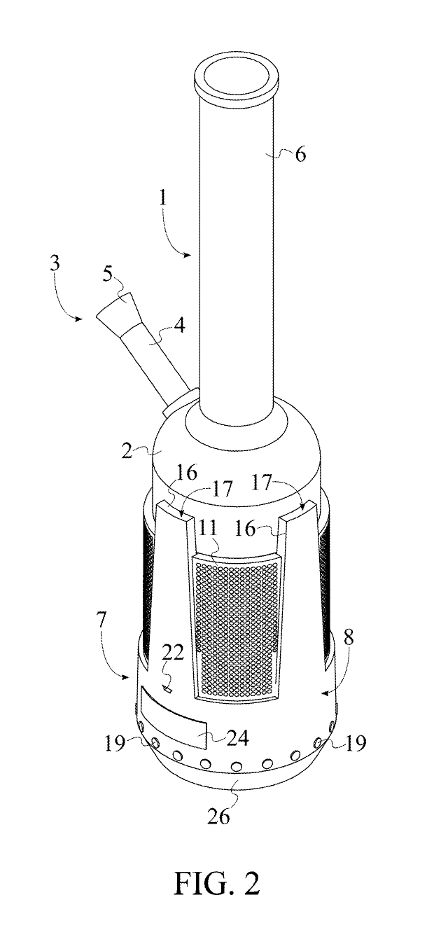

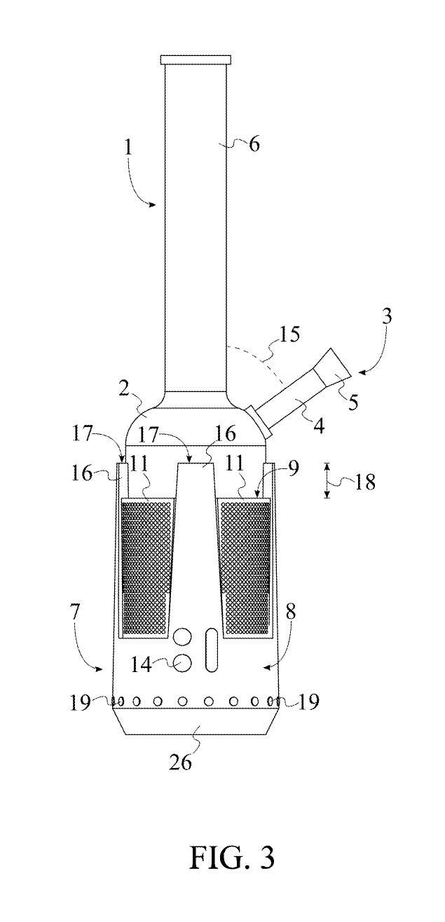

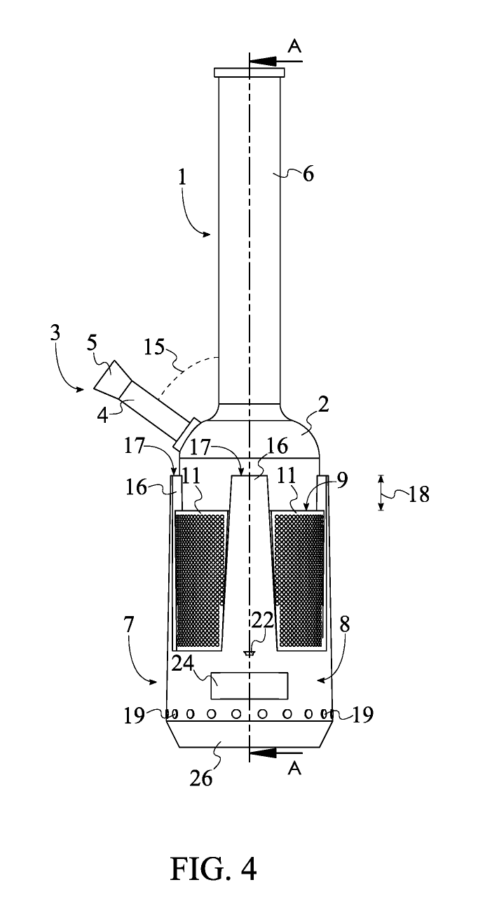

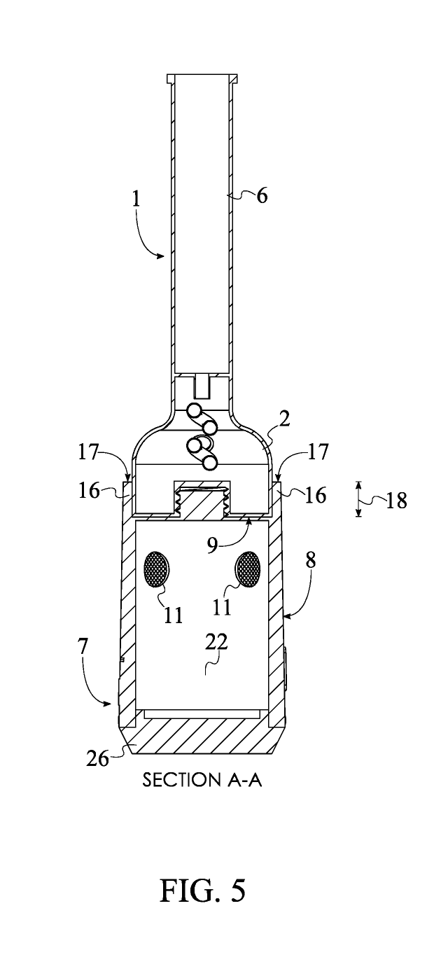

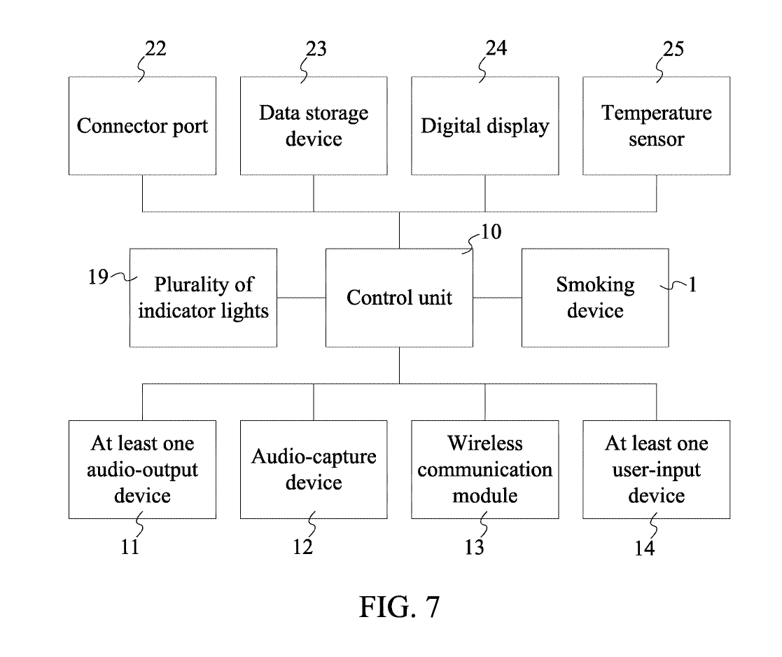

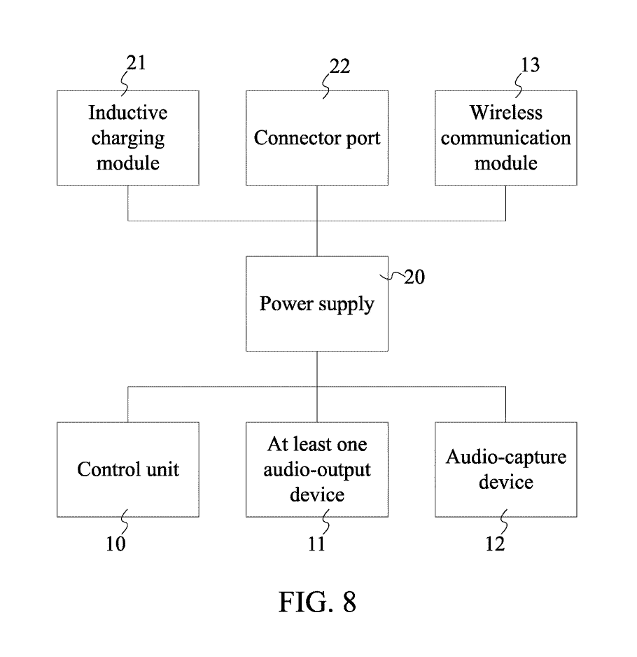

The present invention is a smoking apparatus with wireless communication capability. The present invention is shown in FIGS. 1-6 while electronic and electrical components of the present invention are shown in FIG. 7 and FIG. 8. The present invention comprises a smoking device 1, an electronic base 7, a control unit 10, at least one audio-output device 11, an audio-capture device 12, a wireless communication module 13, and at least one user-input device 14.

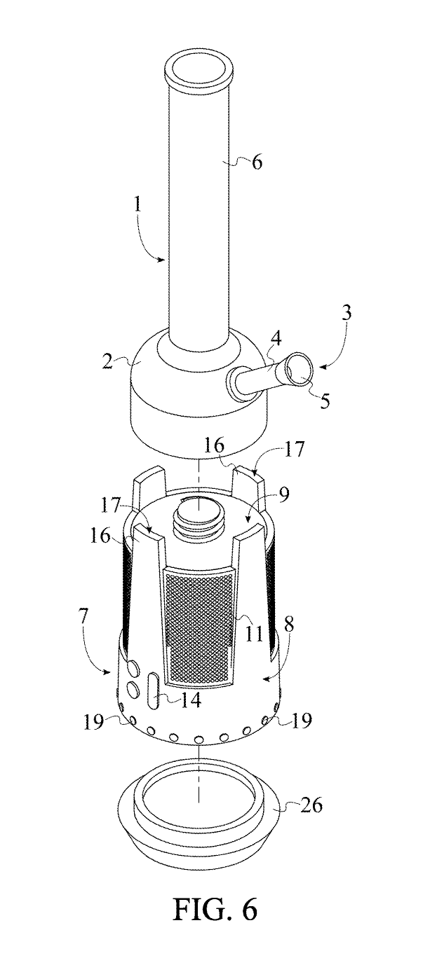

The smoking device 1 is utilized to combust a smokable product such as cannabis, tobacco, or other herbal substance. In the preferred embodiment of the present invention, the smoking device 1 is a bong and as such is able to provide filtration to smoke produced by the combustion of smokable products. The electronic base 7 houses and protects the electronic components of the present invention. As shown in FIG. 6, the smoking device 1 is removably engaged to the electronic base 7, forming a single unit when the smoking device 1 is attached to the electronic base 7 while allowing the smoking device 1 to be easily separated from the electronic base 7 for cleaning. In the preferred embodiment of the present invention, the smoking device 1 may be simply screwed onto or unscrewed from the electronic base 7. The electronic base 7 comprises an outer lateral surface 8 that serves as the exterior-facing portion of the electronic base 7.

The at least one audio-output device 11 includes one or more speakers that are capable of outputting audio around the present invention. The at least one audio-output device 11 is distributed about the outer lateral surface 8, enabling audio to be projected in a 360-degree diameter around the present invention. The at least one audio-output device 11 may be utilized for various applications such as playing music and generating an alarm in the event that the user cannot locate the present invention. In the preferred embodiment of the present invention, each of the at least one audio-output device 11 includes a speaker cover for improving the aesthetic appeal of the present invention. The audio-capture device 12 is a microphone that is capable of voice recognition and voice capture, enabling voice calls to be made via the present invention.

The wireless communication module 13 enables the present invention to be wirelessly tethered to an external electronic device such as a smartphone. In the preferred embodiment of the present invention, the wireless communication module 13 is a Bluetooth module that enables the present invention to be connected to a smartphone or similar electronic device.

The at least one user-input device 14 provides the user with a means of inputting commands. The at least one user-input device 14 is positioned on the outer lateral surface 8 for convenient access by the user and may include buttons, dials, levers, and other types of electronic input devices. The control unit 10 regulates the electronic components of the present invention. The control unit 10 and the wireless communication module 13 are enclosed within the electronic base 7 for protection. The at least one audio-output device 11, the audio-capture device 12, the wireless communication module 13, and the at least one user-input device 14 are electronically connected to the control unit 10. The control unit 10 is thus able to regulate the volume of audio outputted by the at least one audio-output device 11 and is able to recognize and process audio captured through the audio-capture device 12. The control unit 10 is also able to regulate the electronic tethering of the present invention to an electronic device. Finally, the control unit 10 is able to process commands that are inputted through the at least one user-input device 14.

In the preferred embodiment of the present invention, the smoking device 1 comprises a water chamber 2, a slide assembly 3, and an elongated mouthpiece 6. The water chamber 2 holds a quantity of water that is used to filter the smoke produced by combusting an herbal substance. The slide assembly 3 holds an herbal substance and provides a pathway for smoke from a combusting herbal substance to enter the water chamber 2. The elongated mouthpiece 6 is the portion of the slide assembly 3 through which smoke may be inhaled after the smoke is filtered through the water chamber 2. The elongated mouthpiece 6 is normally and removably mounted to the water chamber 2 and may be easily removed from the water chamber 2 for cleaning. The slide assembly 3 is removably mounted to the water chamber 2 as well for convenient cleaning. In the preferred embodiment of the present invention, the slide assembly 3 comprises a stem 4 and a bowl 5. The bowl 5 holds a quantity of herbal substance while smoke from the combusting herbal substance is drawn through the stem 4 into the water chamber 2 for filtration. The stem 4 is removably mounted to the water chamber 2 for convenient removal and cleaning. Additionally, the bowl 5 is terminally connected to the stem 4, opposite to the water chamber 2. As a result, smoke from a combusting herbal substance is drawn through the stem 4 and into the water chamber 2. The elongated mouthpiece 6 is in fluid communication with the slide assembly 3 through the water chamber 2. As a result, smoke is drawn from the slide assembly 3 and filtered within the water chamber 2 before being drawn into the elongated mouthpiece 6. In the preferred embodiment of the present invention, the slide assembly 3 and the elongated mouthpiece 6 are oriented at an acute angle 15 to each other, enabling smoke from the bowl 5 to be drawn downward through the stem 4 and into the water chamber 2. The elongated mouthpiece 6 is oriented vertically relative to the electronic base 7, allowing smoke to be drawn upward from the water chamber 2 after filtration.

The present invention further comprises a plurality of retaining arms 16. The plurality of retaining arms 16 assists in securing the smoking device 1 on the electronic base 7. The plurality of retaining arms 16 is circumferentially distributed about the electronic base 7, forming an enclosure for the smoking device 1 on the electronic base 7. An upper end 17 of each of the plurality of retaining arms 16 is offset from an upper surface 9 of the electronic base 7 by a specified distance 18. This ensures that the plurality of retaining arms 16 is able to extend sufficiently upward to hold the smoking device 1 in place.

The present invention further comprises a plurality of indicator lights 19. The plurality of indicator lights 19 may be utilized for various applications. The plurality of indicator lights 19 is distributed about the outer lateral surface 8 and is thus easily visible on the electronic base 7. The plurality of indicator lights 19 is electronically connected to the smoking device 1 through the control unit 10. As a result, the plurality of indicator lights 19 is activated when the smoking device 1 is utilized (for example, when the user draws from the smoking device 1).

The present invention further comprises a power supply 20. The power supply 20 provides electrical power to the electronic components of the present invention and is preferably rechargeable. The power supply 20 is electrically connected to the control unit 10, the at least one audio-output device 11, the audio-capture device 12, and the wireless communication module 13, allowing these components to draw electrical power from the power supply 20. The present invention may alternatively be electrically connected to an external power source such as an electrical outlet. The present invention may further comprise an inductive charging module 21. The inductive charging module 21 is utilized to wirelessly charge the power supply 20 without the need to connect the power supply 20 to an external power source. The inductive charging module 21 is electrically connected to the power supply 20, allowing the power supply 20 to be charged wirelessly. The present invention further comprises a connector port 22 that enables the power supply 20 to be charged by connecting the present invention to an external power source such as an electrical outlet. The connector port 22 is externally positioned on the electronic base 7 for convenient access by the user. The connector port 22 traverses into the electronic base 7. This forms an opening on the electronic base 7 into which a cable or similar charging accessory may be inserted. The connector port 22 is electronically connected to the control unit 10 and is electrically connected to the power supply 20. The control unit 10 is thus able to regulate and monitor the charging of the power supply 20 while the connector port 22 allows the power supply 20 to be charged by physically connecting the power supply 20 to an external power source.

The present invention further comprises a data storage device 23. The data storage device 23 is utilized to store various types of data including, but not limited to, audio files and usage statistics of the present invention. The data storage device 23 is electronically connected to the control unit 10, enabling the control unit 10 to process and record data to the data storage device 23.

The present invention further comprises a digital display 24. The digital display 24 outputs various information about the present invention to the user. The digital display 24 is positioned on the outer lateral surface 8 and as such is positioned in an easily visible location on the present invention. The digital display 24 is electronically connected to the control unit 10, enabling the control unit 10 to output information to the user through the digital display 24.

The present invention further comprises a temperature sensor 25. The temperature sensor 25 is internally positioned within the smoking device 1 and as such is able to detect the temperature of the water within the water chamber 2. The temperature sensor 25 is electronically connected to the control unit 10, enabling the temperature sensor 25 to transmit the temperature data for the water chamber 2 to the control unit 10.

The present invention further comprises a base cap 26 that enables access to the interior electronic components of the electronic base 7. The base cap 26 is removably engaged to the electronic base 7, opposite to the smoking device 1. As such, the base cap 26 additionally serves as a foundation for the present invention when the present invention is placed on a surface.

Alternative embodiments of the present invention may include additional features such as a heating element, a cooling element, a lighter, and/or a grinder. The heating element and the cooling element may be utilized to respectively heat and cool the water within the water chamber 2. The lighter is utilized to combust an herbal substance within the bowl 5. The grinder may be utilized to physically crush and herbal substance before the herbal substance is placed within the bowl 5.

Although the present invention has been explained in relation to its preferred embodiment, it is understood that many other possible modifications and variations can be made without departing from the spirit and scope of the present invention as hereinafter claimed.

What is claimed is:

1. A smoking apparatus with wireless communication capability comprises:
a smoking device;
an electronic base;
a control unit;
at least one audio-output device;
an audio-capture device;
a wireless communication module;
at least one user-input device;
the electronic base comprises an outer lateral surface;
the smoking device being removably engaged to the electronic base;
the at least one audio-output device being distributed about the outer lateral surface;
the at least one user-input device being positioned on the outer lateral surface;
the control unit and the wireless communication module being enclosed within the electronic base; and
the at least one audio-output device, the audio-capture device, the wireless communication module, and the at least one user-input device being electronically connected to the control unit.

2. The smoking apparatus with wireless communication capability as claimed in claim 1 further comprises:
the smoking device comprises a water chamber, a slide assembly, and an elongated mouthpiece;
the elongated mouthpiece being normally and removably mounted to the water chamber;
the slide assembly being removably mounted to the water chamber; and
the elongated mouthpiece being in fluid communication with the slide assembly through the water chamber.

3. The smoking apparatus with wireless communication capability as claimed in claim 2 further comprises:
the slide assembly and the elongated mouthpiece being oriented at an acute angle to each other.

4. The smoking apparatus with wireless communication capability as claimed in claim 2 further comprises:
the slide assembly comprises a stem and a bowl;
the stem being removably mounted to the water chamber; and
the bowl being terminally connected to the stem, opposite to the water chamber.

5. The smoking apparatus with wireless communication capability as claimed in claim 1 further comprises:
a plurality of retaining arms;
the plurality of retaining arms being circumferentially distributed about the electronic base; and
an upper end of each of the plurality of retaining arms being offset from an upper surface of the electronic base by a specified distance.

6. The smoking apparatus with wireless communication capability as claimed in claim 1 further comprises:
a plurality of indicator lights;
the plurality of indicator lights being distributed about the outer lateral surface; and
the plurality of indicator lights being electronically connected to the smoking device through the control unit.

7. The smoking apparatus with wireless communication capability as claimed in claim 1 further comprises:
a power supply; and
the power supply being electrically connected to the control unit, the at least one audio-output device, the audio-capture device, and the wireless communication module.

8. The smoking apparatus with wireless communication capability as claimed in claim 7 further comprises:
an inductive charging module; and
the inductive charging module being electrically connected to the power supply.

9. The smoking apparatus with wireless communication capability as claimed in claim 7 further comprises:
a connector port;
the connector port being externally positioned on the electronic base;
the connector port traversing into the electronic base;
the connector port being electronically connected to the control unit; and
the connector port being electrically connected to the power supply.

10. The smoking apparatus with wireless communication capability as claimed in claim 1 further comprises:
a data storage device; and
the data storage device being electronically connected to the control unit.

11. The smoking apparatus with wireless communication capability as claimed in claim 1 further comprises:
a digital display;
the digital display being positioned on the outer lateral surface; and
the digital display being electronically connected to the control unit.

12. The smoking apparatus with wireless communication capability as claimed in claim 1 further comprises:
a temperature sensor;
the temperature sensor being internally positioned within the smoking device; and
the temperature sensor being electronically connected to the control unit.

13. The smoking apparatus with wireless communication capability as claimed in claim 1 further comprises:
a base cap; and
the base cap being removably engaged to the electronic base, opposite to the smoking device.
